(19) United States
(12) Patent Application Publication
(10) Pub. No.: US 2007/0268787 A1
(43) Pub. Date: Nov. 22, 2007

(54) METHOD AND APPARATUS FOR A PORTABLE DEVICE

(75) Inventor: Tzi-Yu Jau, Taipei Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: MEDIATEK INC., Hsin-Chu (TW)

(21) Appl. No.: 11/536,981

(22) Filed: Sep. 29, 2006

Related U.S. Application Data
(60) Provisional application No. 60/747,666, filed on May 19, 2006.

(51) Int. Cl. G04B 18/00

(52) U.S. Cl. 368/200

(57) ABSTRACT

A method for a portable device is disclosed. A reference clock is provided. A first time value and a first index are recording at a first time point. A second index is recorded at a second time point. The first time point and the second time point are counted according to the reference clock. The first index and the second index are calculated. A second time value is set according to the calculating result.

### CROSS REFERENCE TO RELATED APPLICATIONS

This application claims the benefit of U.S. Provisional Application No. 60/747,666, filed May 19,2006.

### BACKGROUND OF THE INVENTION

1. Field of the Invention

The invention relates to a correction method and device, and more particularly to a correction method and device for correcting a time value of a real time clock (RTC).

2. Description of the Related Art

FIG. 1 is a schematic diagram of a conventional device, which controls a real time clock (RTC). The device 100 controls a RTC 180 and comprises a crystal 110, a second counter 120, a minute counter 130, an hour counter 140, a day counter 150, a year counter 160, and a processor 170. Assume for the purposes of explanation that the frequency generated by the crystal 110 is 32768 Hz.

The second counter 120 counts pulses from the frequency generated by the crystal 110. When the accumulated count of the second counter 120 reaches 32768, the second counter 120 outputs a notification signal to the minute counter 130 for every 32768 pulses of the frequency. Thus, the accumulated count of the minute counter 130 is increased one unit from zero and the second counter 120 terminates a preceding count and begins a new count. When the accumulated count of the minute counter 130 reaches 60,the minute counter 130 outputs a notification signal to the hour counter 140. Thus, the accumulated count of the hour counter 140 is increased one unit from zero and the minute counter 130 terminates a preceding count and begins a new count.

When the accumulated counts of the hour counter 140 reaches 24, the hour counter 140 outputs a notification signal to the day counter 150. Thus, the accumulated count of the day counter 150 is increased one unit from zero and the hour counter 140 terminates a preceding count and begins a new count. When the accumulated counts of the day counter 150 reaches a preset value, the day counter 150 outputs a notification signal to the year counter 160. Thus, the accumulated count of the year counter 160 is increased one unit from zero and the day counter 150 terminates a preceding count and begins a new count.

When the accumulated count of the second counter 120, the minute counter 130, the hour counter 140, the day counter 150, or the year counter 160 is changed, the corresponding counter notices a processor 170 for updating time of a real time clock (RTC) 180.

Thus the accuracy of the RTC 180 is determined by the frequency generated by the crystal 110. The frequency generated by the crystal 110, however, is easily altered by two causes, temperature and frequency drift, thus, crystal 110 generates an incorrect frequency.

The frequency generated by the crystal 110 changes with environmental temperature. The frequency generated by the crystal 110 has a drift error between +20 ppm and −20 ppm due to manufacturing procedures. If the crystal 110 generates an incorrect frequency, the RTC 180 time is incorrect.

To solve the described problems, a conventional method corrects the accumulated count of the second counter 120. As shown in FIG. 2, the device 200 comprises a correction register 290 for correcting an RTC 280. A processor 270 updates the accumulated count of a second counter 220 according to the stored value of the correction register 290.

Although the RTC 280 can maintain a correct time by use of a conventional method, the correction register 290, and additional element, is required for storage of correct values. Thus, device cost is increased and the usable space is reduced.

### BRIEF SUMMARY OF THE INVENTION

A method and apparatus for a portable device are provided. An exemplary embodiment of a method for a portable device is described in the following. A reference clock is provided. A first time value and a first index are recorded at a first time point. A second index is recorded at a second time point. The first time point and the second time point are counted according to the reference clock. The first index and the second index are calculated. A second time value is set according to the calculated result.

An exemplary embodiment of an apparatus for a portable device comprises a counter and a processing module. The counter counts and provides a first index and a second index according to a reference clock. The processing module records a first time value provided by a real time clock and the first index at a first time point and the second index at a second time point and calculates the first and second indexes such that the real time clock provides a second time value. The first time point and the second time point are counted according to the reference clock.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram of a conventional device;

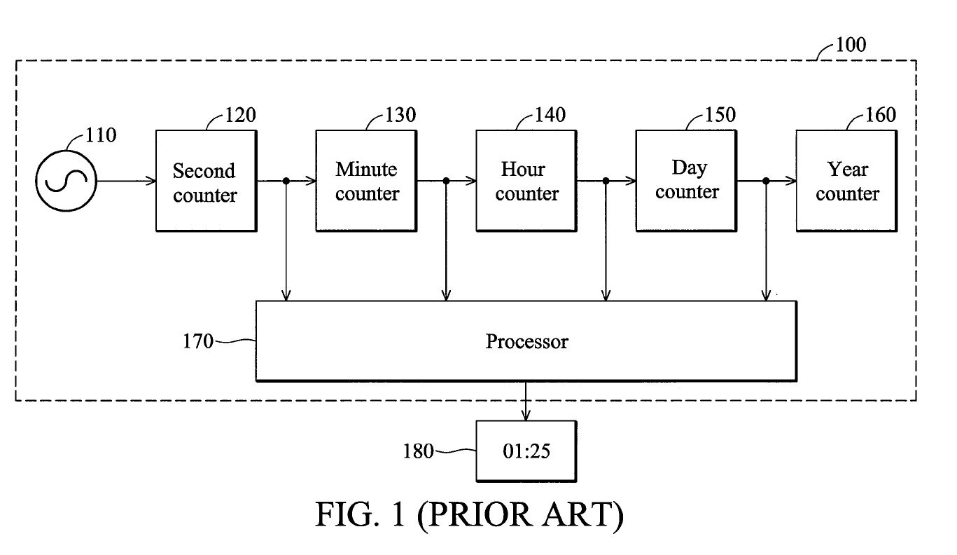

FIG. 2 is a schematic diagram of another conventional device;

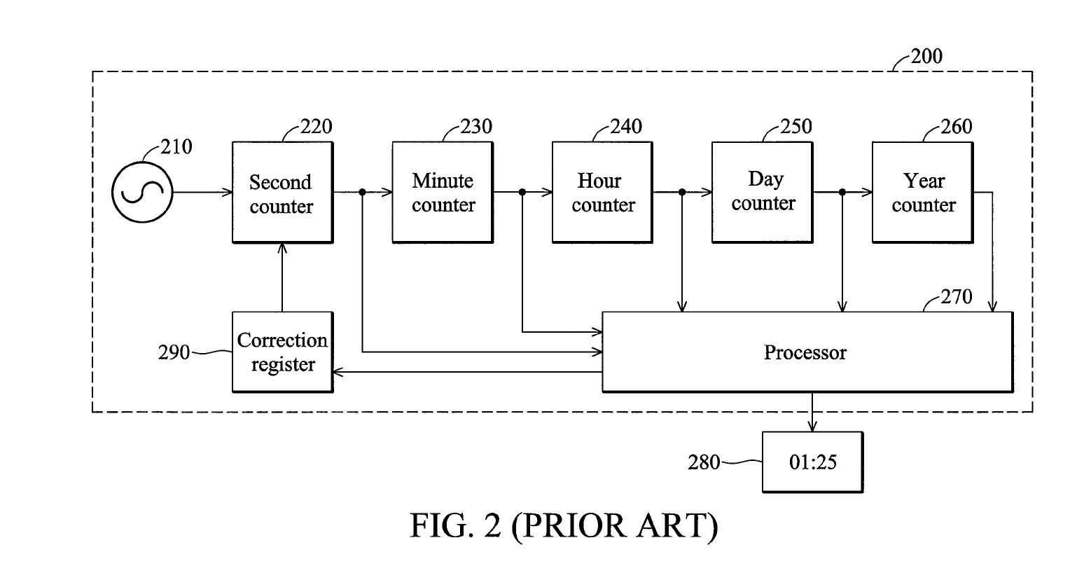

FIG. 3 is a schematic diagram of an exemplary embodiment of a device;

FIG. 4 is a schematic diagram of the calculating performed by the processing module; and

FIG. 5 is a flowchart of a method applied in a portable device.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

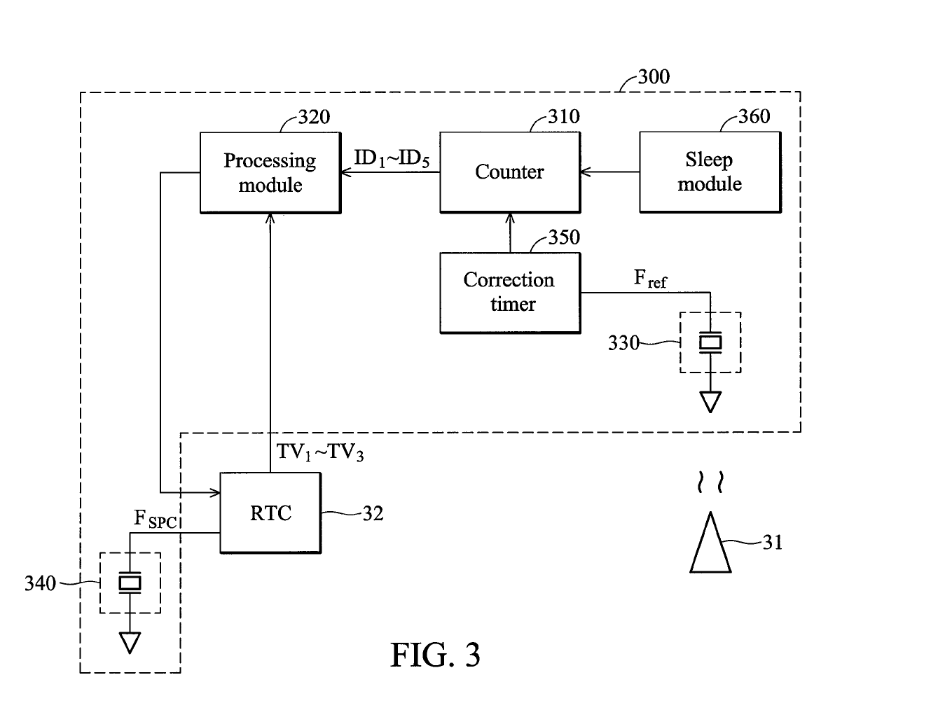

FIG. 3 is a schematic diagram of an exemplary embodiment of a device. The device 300 is applied to a portable device, such as a mobile phone. The device 300 comprises a counter 310, and a processing module 320. The counter 310 applied to debug counts pulses from a reference clock F_{ref} and provides indexes ID₁˜ID₅. A real time clock (RTC) 32 provides time values TV₁˜TV₃.

At time point T₁, the processing module 320 records the time value TV₁ and the index ID₁. At time point T₂, the processing module 320 records the index ID₂ and calculates the indexes ID₁ and ID₂ such that the RTC 32 provides the time value TV₂. The time points T₁ and T₂ are counted according to the reference clock F_{ref}.

The device 300 further comprises frequency generators 330 and 340. The frequency generator 330 is a crystal for generating the reference clock F_{ref}. The frequency generator 340 generates a specific clock F_{SPC}. The RTC 32 provides time values TV₁ and TV₃ according to the specific clock F_{SPC}. In this embodiment, the frequency of the reference clock F_{ref} is 13 MHz and that of the specific clock F_{SPC} is 32 KHz.

The drift of the reference clock F_{ref} is approximately less than ±10 ppm and that of a system clock, which generated by a base station 31, is less than ±0.05 ppm. The frequency of the reference clock F_{ref} is equal to that of the system clock. In some embodiments, since the drift of the system clock is less than that of the reference clock F_{ref}, the system clock is utilized to correct the reference clock F_{ref}.

When the specific clock F_{SPC} is wrong, the time value provided by the RTC 32 is also wrong. Thus, the processing module 320 updates the time value provided by the RTC 32 during a preset period.

For the purposes of description assume the time value provided by the RTC 32 is 01:35 and the processing module 320 updates the time value provided by the RTC 32 every hour. After one hour, the time value provided by the RTC 32 should be 02:25. The real time value provided by the RTC 32 is 02:20 due to the inaccurate specific clock F_{SPC}. Thus, the processing module 320 updates the time value provided by the RTC 32 from 02:20 to 02:25.

Additionally, the counter 310 begins counting according to a correction timer 350 counting time according to the reference clock F_{ref}. Because the frequency of the reference clock F_{ref} is 13 MHz, the correction timer 350 increases the accumulated count of the counter 310 by one unit every

$$\frac{120}{26} ms .$$

When the correction timer 350 counts to time point T₁, the processing module 320 records the time value TV₁ and the index ID₁. When the correction timer 350 counts time to the time point T₂, the processing module 320 records the index ID₂ and then directs the RTC 32 to provide a correct time value according to the indexes ID₁ and ID₂.

The duration between time points T₁ and T₂ should be a fixed value but the processing module 320 does not immediately record the index ID₂ because a system comprising the device 300 is busy. Thus, the recording delay time is considered by the processing module 330.

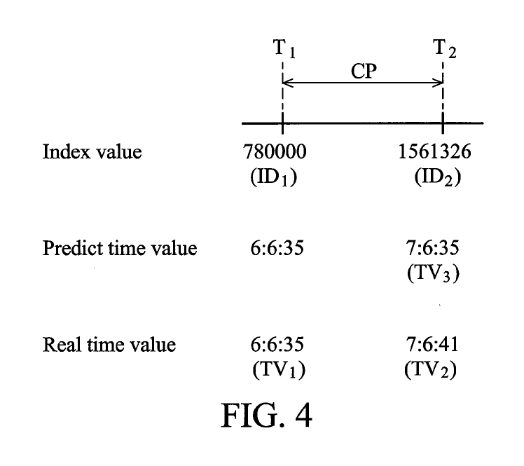

FIG. 4 is a schematic diagram showing a calculation performed by the processing module. Assuming the counter 310 requires one hour to count 780000 times and the processing module 320 updates the time value of the RTC every hour.

At the time point T₁, the time value TV₁ recorded by the processing module 320 is 6:6:35 and the index ID₁ recorded by the processing module 320 is 780000. At the time point T₂, the index ID₂ recorded by the processing module 320 should be 1560000. The real index ID₂ is, however, 1561326 because the system is busy.

The processing module 320 calculates a difference DIFF₁ between indexes ID₁ and ID₂. The difference DIFF₁ is expressed by the following equation (1):

DIFF₁=ID₂−ID₁=1561326−780000=781326 Equation (1)

Next, the processing module 320 converts the difference DIFF₁ into a correction time value CTV₁. The correction time value CTV₁ is expressed by the following equation (2):

$${CTV}_{1} = 781326 \times \frac{120}{26} ms = 3600 sec + 6 sec + 0.12 sec \qquad Equation ( 2 )$$

The processing module 320 calculates the sum of the time value TV₁ and the correction time value CTV₁ to set the time value TV₂. Thus, the time value TV₂ is 7:6:41.

In some embodiments, at the time point T₁, the processing module 320 records the time value TV₁ and the index ID₁. At the time point T₂, the processing module 320 records the time value TV₃ and the index ID₂, calculates a difference between the indexes ID₁ and ID₂, and adjusts the time value TV₃ to reflect the difference, thus, the RTC 310 provides the time value TV₂.

For example, at the time point T₁, the time value TV₁ is 6:6:35 and the index ID₁ is 780000. At the time point T₂, the time value TV₃ is 7:6:35 and the index ID₂ is 1561326.

The processing module 320 calculates a difference DIFF₂ between the indexes ID₁ and ID₂. The difference DIFF₂ is expressed by the following equation (3):

DIFF₂=ID₂−ID₁=1561326−780000=781326 Equation (3)

Next, the processing module 320 obtains an adjustment time value ATV according to the difference DIFF₂. The adjustment time value ATV is expressed by the following equation (4):

$$ATV = ( 781326 - 780000 ) \times \frac{120}{26} ms = 6 sec + 0.12 sec \qquad Equation ( 4 )$$

The processing module 320 adjusts the time value TV₃ according to the adjustment time value ATV. In some embodiments, the time value TV₂ is equal to the sum of the time value TV₃ and the adjustment time value ATV. Thus, the time value TV₂ is 7:6:41.

Additionally, since the counter 310 stops counting when in sleep mode, the device 300 further comprises a sleep module to ensure the counter 310 counting from a correct index, when the sleep mode transits to a normal mode. The sleep module 360 controls the counter 310 according to the duration of the sleep mode.

Before the device 300 enters the sleep mode, the sleep module 360 records the index ID₄ provided by the counter 310 and then transmits the duration of the sleep mode into a sleep index SID. When the device 300 leaves the sleep mode, the sleep module 360 updates a calculation result, that is the sum of the index ID₄ and the sleep index SID, to the counter 310. Thus, the counter 310 counts from the index ID₅. In this embodiment, the index ID₅ is equal to the sum of the index ID₄ and the sleep index SID.

For example, before the device 300 enters sleep mode, the index ID₄ provided by the counter 310 is 124 and the duration of the sleep mode is 3 sec. The sleep module 360 records the index ID₄ and transmits the duration of the sleep mode into a sleep index SID. The sleep index is expressed by the following equation (5):

$$SID = 3 sec \times \frac{26}{120} k s = 650 \qquad Equation ( 5 )$$

When the device 300 leaves the sleep mode, the index ID₅ is expressed by the following equation (6):

ID5=ID4+SID=124+650=774 Equation (6)

Thus, when device 300 again enters the normal mode, the counter 310 starts to count form 774.

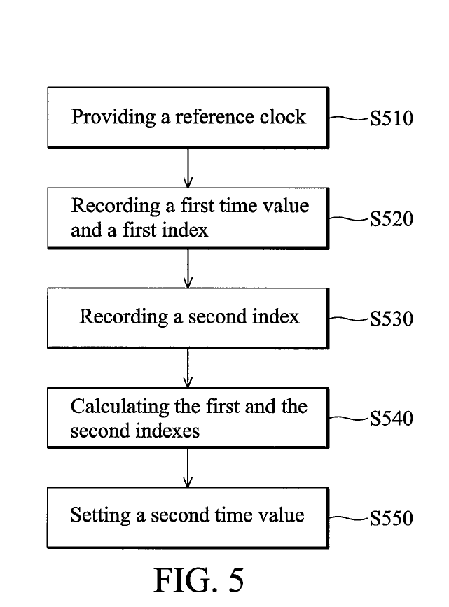

FIG. 5 is a flowchart of a method. The method is applied in a portable device. A reference clock F_{ref} is provided (step S510). Since the reference clock F_{ref} may have a drift error, a system clock provided by a base station is utilized to correct the reference clock F_{ref}.

At a first time point, a first time value and a first index are recorded (step S520). Taking FIG. 3 as an example, the processing module 320 records the time value TV₁ provided by the RTC 32 and records the index ID₁ provided by the counter 310 at the time point T₁. In this embodiment, the RTC 32 provides a time value according to the specific clock F_{SPC} generated by the frequency generator 340. The frequency of the reference clock F_{ref} exceeds that of the specific clock F_{SPC}.

At a second time point, a second index is recorded (step S530). In this embodiment, the first time point and the second time point are counted according to the reference clock. Taking FIG. 3 as an example, the processing module 320 records the index ID₂ provided by the counter 310 at the time point T₂. In some embodiments, the processing module 320 further records the time value TV₃ provided by the RTC 32.

The first index and the second index are calculated (step S540). A second time value is set according to the calculating result (step S550). In this embodiment, the processing module 320 calculates a difference between the indexes ID₁ and ID₂ and transforms the difference into a correction time value. The sum of the time value TV₁ and the correction time value are calculated to obtain the second time value. In some embodiments, when a third time value is recorded, the processing module 320 adjusts the third time value for obtained the second time value according to a difference of the index values ID₁ and ID₂.

Additionally, in some embodiments, a correction timer is utilized. The correction timer counts time according to the reference clock. When the correction timer counts time to a first time point, the first time value and the first index are recorded. When the correction timer counts time to a second time point, the second index is recorded.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for a portable device, comprising:
providing a reference clock;
recording a first time value and a first index at a first time point;
recording a second index at a second time point, wherein the first time point and the second time point are counted according to the reference clock;
calculating the first index and the second index; and
setting a second time value according to the calculating result.

2. The method as claimed in claim 1, wherein the calculating step comprises calculating the difference between the first index and the second index.

3. The method as claimed in claim 2, wherein the second time value is set in light of the difference.

4. The method as claimed in claim 2, further comprising:
recording a third time value at the second time point; and
adjusting the third time value in light of the difference for setting the second time value.

5. The method as claimed in claim 1, wherein a system clock corrects the reference clock.

6. The method as claimed in claim 5, wherein a base station provides the system clock.

7. The method as claimed in claim 1, wherein a correction timer for implementing the recording steps is turned on, the correction timer counting time according to the reference clock.

8. The method as claimed in claim 7, wherein the first time value and the first index are recorded when the correction timer counts time to the first time point and the second index is recorded when the correction timer counts time to the second time point.

9. The method as claimed in claim 1, wherein the calculating step comprises:
calculating the difference between the first index and the second index;
converting the difference into a correct time value according to the reference clock; and
adding up the first time value and the correct time value.

10. The method as claimed in claim 9, wherein the second time value is equal to the sum of the first time value and the correct time value.

11. The method as claimed in claim 1, wherein the first time value is provided by a specific clock.

12. The method as claimed in claim 11, the frequency of the reference clock exceeds that of the specific clock.

13. An apparatus for a portable device, comprising:
a counter counting and providing a first index and a second index according to a reference clock; and
a processing module recording a first time value provided by a real time clock and the first index at a first time point and the second index at a second time point and calculating the first and second indexes such that the real time clock provides a second time value, wherein the first time point and the second time point are counted according to the reference clock.

14. The apparatus as claimed in claim 13, further comprising a first frequency generator to provide the reference clock.

15. The apparatus as claimed in claim 14, wherein the first frequency generator is a crystal.

16. The apparatus as claimed in claim 13, further comprising a second frequency generator to provide a specific clock.

17. The apparatus as claimed in claim 16, wherein the real time clock provides the first time value according to the specific clock.

18. The apparatus as claimed in claim 17, wherein the frequency of the reference clock exceeds that of the specific clock.

19. The apparatus as claimed in claim 13, wherein the reference clock is corrected by a system clock.

20. The apparatus as claimed in claim 19, wherein the system clock is provided by a base station.

21. The apparatus as claimed in claim 13, further comprising a correction timer counting time according to the reference clock.

22. The apparatus as claimed in claim 21, wherein the processing module records the first time value and the first index when the correction timer counts time to the first time point and records the second index when the correction timer counts time to the second time point.

23. The apparatus as claimed in claim 13, wherein the processing module calculates the difference between the first and the second indexes and the real time clock provides the second time value according to the difference.

24. The apparatus as claimed in claim 23, wherein the processing module further records a third time value at the second time point and adjusts the third time value according to the difference.

25. The apparatus as claimed in claim 24, wherein the second time value is the adjusted third time value.

26. The apparatus as claimed in claim 13, wherein the processing module calculates the difference between the first and the second indexes, converts the difference into a correct time value according to the reference clock, and calculates the sum of the first time value and the correct time value to set the second time value.

27. The apparatus as claimed in claim 24, wherein the second time value is equal to the sum of the first time value and the correct time value.

28. The apparatus as claimed in claim 13, wherein the counter stops counting in a sleep mode and counts continuously in a normal mode.

29. The apparatus as claimed in claim 28, further comprising a sleep module for controlling the counter according to the sleep mode duration.

30. The apparatus as claimed in claim 29, wherein the counter provides a fourth index in the sleep mode and provides a fifth index in the normal mode.

31. The apparatus as claimed in claim 30, wherein the sleep module converts the sleep mode duration into a sleep index and adds up the fourth index and the sleep index such that the counter provides the fifth index in the normal mode.

32. The apparatus as claimed in claim 31, wherein the sum of the fourth index and the sleep index is equal to the fifth index.

33. The apparatus as claimed in claim 31, wherein the counter is utilized for debugging.

34. The apparatus as claimed in claim 13, wherein the portable device is a mobile phone.
